(19) United States
(12) Patent Application Publication
(10) Pub. No.: US 2008/0046519 A1
(43) Pub. Date: Feb. 21, 2008

(54) SYSTEM AND METHOD FOR MESSAGING TO EDIT A FILE

(75) Inventors: Chung-I Lee, Tu-Cheng (TW); Hai-Hong Lin, Shenzhen (CN); De-Yi Xie, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/616,875

(22) Filed: Dec. 28, 2006

(30) Foreign Application Priority Data
Aug. 21, 2006 (CN) 200610200813.0

(51) Int. Cl. G06F 15/16; G06F 17/00

(52) U.S. Cl. 709/206; 715/255; 709/203

(57) ABSTRACT

A method for messaging to edit a file, the method includes the steps of: assigning an editor of a case; uploading to-be-edited file(s) of the case to an application server (30), and saving the to-be-edited file(s) as a case file in a database server (40) connected to the application server; messaging the editor to edit the case file through an editor computer (20) connected to the application server; transmitting the case file from the database server to the editor computer, and editing the case file by the editor; and messaging edit results of the case file generated by the editor to a corresponding drafter computer (10) connected to the application server. A related system is also provided.

### BACKGROUND OF THE INVENTION

1. Field of the Invention

The present invention is related to systems and methods for messaging to edit a file.

2. Description of Related Art

A document management system (DMS) is a computer system (or set of computer programs) used to track and store electronic documents and/or images of paper documents. Document management systems commonly provide storage, versioning, metadata, security, as well as indexing and retrieval capabilities. The DMS has some overlap with the concepts of content management systems (CMS) and is often viewed as a component of enterprise content management systems (ECMS) and related to digital asset management (DAM). The DMS saves much time and cost in managing documents for enterprise.

However, the current DMS generally can not provide an efficient common platform for drafters in drafter computers to draft files and corresponding editors in editor computers to edit the files via a network, especially when the drafter computers and the editor computers are located at different places. The current procedures of edit files/documents are manually. The manual procedure is generally time-consuming and corresponding labor costs can be high.

Accordingly, what is needed is a system and method for messaging to edit a file, which can save time and labor cost.

### SUMMARY OF THE INVENTION

One preferred embodiment provides a system for messaging to edit a file. The system includes an application server and a database server. The application server includes an editor managing module, an uploading module, a transmitting module, and a messaging module. The editor managing module is used for assigning an editor of a case. The uploading module is used for uploading to-be-edited file(s) of the case to the application server, and saving the to-be-edited file(s) as a case file in the database server. The transmitting module is used for transmitting the case file from the database server to an editor computer connected to the application server for editing by the editor. The messaging module is used for automatically messaging the editor to edit the case file through the editor computer, and for messaging editing results of the case file to a corresponding drafter computer connected to the application server.

Another preferred embodiment provides a method for messaging to edit a file. The method includes the steps of: assigning an editor of a case; uploading to-be-edited file(s) of the case to an application server, and saving the to-be-edited file(s) as a case file in a database server connected to the application server; messaging the editor to edit the case file through an editor computer connected to the application server; transmitting the case file from the database server to the editor computer, and editing the case file by the editor; and messaging edit results of the case file generated by the editor to a corresponding drafter computer connected to the application server.

Other systems, methods, features, and advantages will be or become apparent to one skilled in the art upon examination of the following drawings and detailed description.

### BRIEF DESCRIPTION OF THE DRAWINGS

FIG. 1 is a schematic diagram of hardware configuration of a system for messaging to edit a file in accordance with one preferred embodiment, the system including an application server and a database server;

FIG. 2 is a schematic diagram of function modules of the application server and files stored in the database server in FIG. 1; and

FIG. 3 is a flowchart of a method for messaging to edit a file in accordance with one preferred embodiment.

### DETAILED DESCRIPTION OF THE INVENTION

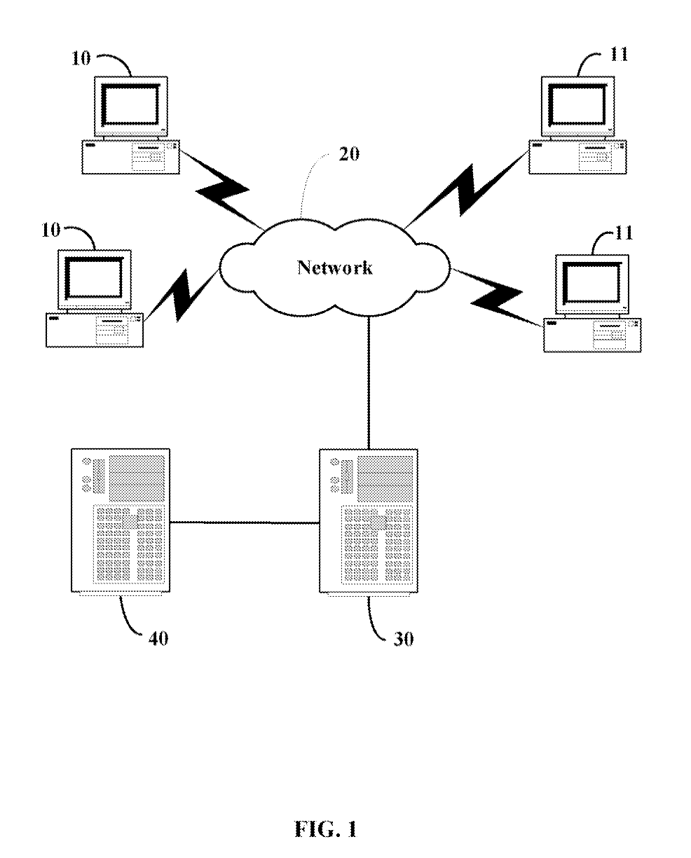

FIG. 1 is a schematic diagram of hardware configuration of a system for messaging to edit a file in accordance with one preferred embodiment. The hardware configuration may typically include a plurality of drafter computers 10, a plurality of editor computers 11, an application server 30, and a database server 40. The drafter computers 10 and the editor computers 11 may be notebook computers, desktop computers, or personal digital assistants (PDAs). The drafter computers 10 and the editor computers 11 are located at remote locations, and are connected with the application server 30 via a network 20. The editor computers 11 are configured to receive a case file from the drafter computers 10, and to edit the case file thereby yielding editing results to be sent to the drafter computers 10. The network 20 may be an intranet, the Internet, or any other suitable communication networks. The application server 30 and the database server 40 may by desktop servers, rack mount servers, pedestal servers, or blade servers.

The database server 40 is connected with the application server 30 via a database connection (not shown), and is used for storing the case file and the editing result file. Wherein, the case file may be a professional file, for example, a patent file or a production plan file, and may be in text format and/or graphic format. The editing result file may include a result flag that indicates whether the case file is satisfactory or unsatisfactory. If the case file is unsatisfactory, the editing result file further includes contents of the case file that need to be further revised.

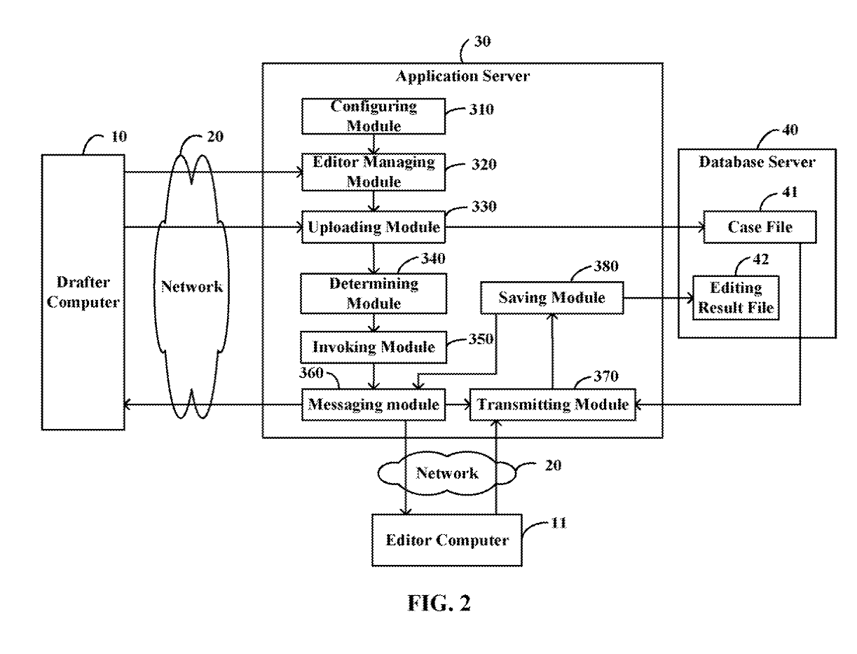

FIG. 2 is a schematic diagram of function modules of the application server 30 and files stored in the database server 40. The application server 30 mainly includes a configuring module 310, an editor managing module 320, an uploading module 330, a determining module 340, an invoking module 350, a messaging module 360, a transmitting module 370, and a saving module 380.

The configuring module 310 is used for configuring an automatic messaging mechanism. Wherein, the automatic messaging mechanism is to automatically message an editor to edit a case file, and to automatically message editing results of the case file to the drafter computer 10.

The editor managing module 320 is used for assigning an editor of a case.

The uploading module 330 is used for uploading to-be-edited file(s) of the case to the application server 30, and saving the to-be-edited file(s) as a case file 41 in the database server 40.

The determining module 340 is used for determining whether the automatic messaging mechanism needs to be invoked.

The invoking module 350 is used for invoking the automatic messaging mechanism when the determining module 340 determines that the automatic messaging mechanism needs to be invoked.

The messaging module 360 is used for automatically messaging the editor assigned by the editor managing module 320 to edit the case file 41 through the editor computer 11.

The transmitting module 370 is used for transmitting the case file 41 from the database server 40 to the editor computer 11 for editing by the editor.

The saving module 380 is used for saving edit results of the case file 41 generated by the editor as an editing result file 42 in the database server 40.

The messaging module 360 is further used for automatically messaging the editing result file 42 to a corresponding drafter computer 10.

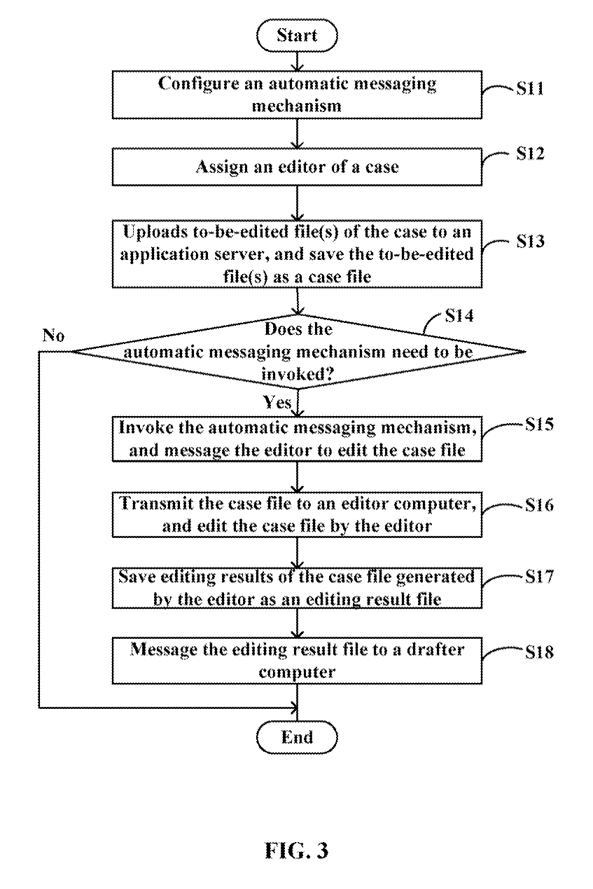

FIG. 3 is a flowchart of a method for messaging to edit a file in accordance with one preferred embodiment.

In step S11, the configuring module 310 configures an automatic messaging mechanism. Wherein, the automatic messaging mechanism is to automatically message an editor to edit a case file, and to automatically message editing results of the case file to a drafter computer 10.

In step S12, the editor managing module 320 assigns an editor of a case via the drafter computer 10.

In step S13, the uploading module 330 uploads to-be-edited file(s) of the case to the application server 30 via the drafter computer 10, and saves the to-be-edited file(s) as a case file 41 in the database server 40.

In step S14, the determining module 340 determines whether the automatic messaging mechanism needs to be invoked.

In step S15, if the automatic messaging mechanism needs to be invoked, the invoking module 350 invokes the automatic messaging mechanism, and the messaging module 360 sends the task message to the editor that messages the editor to edit the case file 41 through the editor computer 10.

In step S16, the transmitting module 370 transmits the case file 41 from the database server 40 to the editor computer 11. And then the editor edits the case file 41 through the editor computer 11, and generates editing results of the case file 41.

In step S17, the saving module 380 saves the edit results of the case file 41 as an editing result file 42 in the database server 40.

In step S18, the messaging module 360 messages the editing result file 42 to the drafter computer 10.

If the automatic messaging mechanism does not need to be invoked in step S14, the procedure ends.

It should be emphasized that the above-described embodiments of the preferred embodiments, particularly, any “preferred” embodiments, are merely possible examples of implementations, merely set forth for a clear understanding of the principles of the invention. Many variations and modifications may be made to the above-described preferred embodiment(s) without departing substantially from the spirit and principles of the invention. All such modifications and variations are intended to be included herein within the scope of this disclosure and the above-described preferred embodiment(s) and protected by the following claims.

What is claimed is:

1. A system for messaging to edit a file, the system comprising an application server and a database server, the application server comprising:
an editor managing module for assigning an editor of a case;
an uploading module for uploading to-be-edited file(s) of the case to the application server, and saving the to-be-edited file(s) as a case file in the database server;
a transmitting module for transmitting the case file from the database server to an editor computer connected to the application server for editing by the editor; and
a messaging module for automatically messaging the editor to edit the case file through the editor computer, and for messaging editing results of the case file to a corresponding drafter computer connected to the application server.

2. The system according to claim 2, wherein the application server further comprises:
a configuring module for configuring an automatic messaging mechanism;
a determining module for determining whether the automatic messaging mechanism needs to be invoked before editing the case file; and
a saving module for saving the editing results as an editing result file in the database server.

3. The system according to claim 2, wherein the editing result file comprises a result flag that indicates whether the case file is satisfactory or unsatisfactory.

4. The system according to claim 3, wherein if the case is unsatisfactory, the editing result file further includes contents of the case file that need to be further revised.

5. A computer-based method for messaging to edit a file, the method comprising the steps of:
assigning an editor of a case;
uploading to-be-edited file(s) of the case to an application server, and saving the to-be-edited file(s) as a case file in a database server connected to the application server;
messaging the editor to edit the case file through an editor computer connected to the application server;
transmitting the case file from the database server to the editor computer, and editing the case file by the editor; and
messaging edit results of the case file generated by the editor to a corresponding drafter computer connected to the application server.

6. The method according to claim 5, further comprising the steps of:
configuring an automatic messaging mechanism; and
invoking the automatic messaging mechanism before editing the case file by the editor.

7. The method according to claim 5, further comprising the step of: saving the editing results as an editing result file in the database server.
